(19) United States
(12) Patent Application Publication
(10) Pub. No.: US 2009/0071825 A1
(43) Pub. Date: Mar. 19, 2009

(54) GAS SENSOR DESIGNED TO ENSURE STABILITY OF WATERPROOFING OF AIR FLOW PATH

(75) Inventor: Masanobu Yamauchi, Kariya-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/049,927

(22) Filed: Mar. 17, 2008

(30) Foreign Application Priority Data
Mar. 16, 2007 (JP) 2007-068675

(51) Int. Cl. G01N 27/26

(52) U.S. Cl. 204/406

(57) ABSTRACT

A gas sensor equipped with an elastic member which is disposed hermetically in an open end of an air cover joined to a housing. The elastic member has a vertical hole, an air flow path, and lead-retaining holes through which leads pass to establish electric connections between a sensing device and an external device. The air flow path extends from the vertical hole to an outer peripheral surface of the elastic member to direct air having entered at air inlets to the vertical hole. An assembly of an air-permeable filter and a support is fit elastically in the vertical hole of the elastic member, thereby asserting the stability of adhesion between the vertical hole and the filter even if the filter is thermally deteriorated to ensure the waterproofing of the gas sensor.

### CROSS REFERENCE TO RELATED DOCUMENT

The present application claims the benefit of Japanese Patent Application No. 2007-68675 filed on Mar. 16, 2007, the disclosure of which is incorporated herein by reference.

### BACKGROUND OF THE INVENTION

1. Technical Field of the Invention

The present invention relates generally to an improved structure of a gas sensor which measures the concentration of gas to provide a signal indicative thereof, and more particularly to such a gas sensor designed to ensure the stability of waterproofing or watertight sealing of an air flow path in the gas sensor

2. Background Art

There are known gas sensors installed in an exhaust system of automotive internal combustion engines to measure the concentration of oxygen (O₂) contained in exhaust emissions. For example, Japanese Patent First Publication No. 11-248671 discloses such a type of gas sensors as illustrated in FIG. 17 The gas sensor 9 is equipped with a sensing device 910 working to measure the concentration of a given component contained in gas. The sensing device 910 is retained in a housing 911 through a porcelain insulator 93. An air cover 92 is joined to a base end (i.e., an upper end, as viewed in the drawing) of the housing 911.

An elastic bush 93 is fit in the base end of the air cover 92 to seal it hermetically. The elastic bush 93 has leads 912 passing therethrough. The leads 912 are joined electrically to the sensing device 910.

An outer cover 94 is placed to cover to the periphery of a base end portion of the air cover 92. The outer cover 94 and the air cover 92 are crimped inwardly at three locations to form annular grooves 940 to establish a firm joint therebetween.

An air-permeable filter 95 having waterproofing properties is disposed between the air cover 92 and the outer cover 94 and retained firmly by the two crimped grooves 940. Air is introduced as a reference gas into air inlets 921 in the air cover 92 through the air-permeable filter 95 from holes 941 formed in the outer cover 94 and into the gas sensor 9.

The installation of the air-permeable filter 95 in the gas sensor 1 is achieved by placing the air-permeable flter 95 and the outer cover 94 around the periphery of the air cover 92 and crimping the outer cover 94. This requires a lot of steps in the installation of the air-permeable filter 95, thus interfering with the improvement of productivity of the gas sensor 9.

When the air enters the gas sensor 9 from the holes 941 of the outer cover 94, pollution objects are sometimes adhered to the air-permeable filter 95 partially exposed to the holes 941 and clog the air-permeable filter 95, thereby resulting in lowered permeability of the air-permeable filter 95.

The air-permeable filter 95 is disposed between the air cover 92 and the outer cover 94, thus facilitating the transfer of ambient heat to the air-permeable filter 95 through the air cover 92 and the outer cover 94. Consequently, use of the gas sensor 9 in the exhaust system of the internal combustion engine for a long time will result in thermal deterioration of the air-permeable filter 95. This results in a decrease in watertight sealing of the air inlets 921, which causes the water to enter the gas sensor 9.

### SUMMARY OF THE INVENTION

It is therefore a principal object of the invention to avoid the disadvantages of the prior art.

It is another object of the invention to provide an improved structure of a gas sensor designed to have high productivity and ensure the waterproofing of an air flow path in the gas sensor.

According to one aspect of the invention, there is provided an improved structure of a gas sensor designed to have high productivity and ensure the waterproofing or watertight sealing of an air flow path through which air is admitted into the gas sensor The gas sensor has a length with a base end and a top end opposed to the base end and comprises: (a) a housing having a base end facing the base end of the gas sensor and a top end facing the top end of the gas sensor; (b) a sensing device that measures a concentration of gas and provides a signal indicative thereof, the sensing device being retained inside the housing; (c) an air cover having a length with a base end and a top end opposed to the base end, the air cover being joined at the top end thereof to the base end of the housing to extend along the length of the gas sensor toward the base end of the gas sensor, the base end of the air cover having an opening; (d) leads coupled electrically with the sensing device, the leads extending outside the air cover through the opening of the base end of the air cover; (e) an elastic member having a top end and a base end opposed to the top end, the elastic member being disposed hermetically in the opening of the base end of the air cover, the elastic member having a vertical hole, an air flow path, and lead-retaining holes through which the leads pass, the vertical hole extending vertically of the gas sensor within the elastic member to have an open end oriented inside the air cover and a closed end opposed to the open end, the air flow path extending from the vertical hole to an outer peripheral surface of the elastic member; (f) a hollow cylindrical air-permeable filter disposed in the vertical hole of the elastic member, (g) an air-permeable support fit in the air-permeable filter to form an elastic nip along with the elastic member in which the air-permeable filter is held; (h) a plurality of crimped recesses in an wall of the air cover which exert mechanical pressure on the elastic member inwardly in a radius direction of the elastic member, the crimped recesses being located away from each other in a lengthwise direction of the air cover; and (i) an air inlet formed in a portion of the wall of the air cover between the crimped recesses. The air inlet communicates with the air flow path to admit air into the air-permeable filter.

After entering the air inlet of the air cover, the air goes within the air flow path of the elastic member into the air-permeable filter.

Subsequently, the air enters the support and goes out of it to inside the air cover.

The air-permeable Filter may be disposed in the vertical hole along with the support fit in the air-permeable filter, thus facilitating the ease of installing the air-permeable filter and the support in the elastic member and results in improved productivity of the gas sensor.

The air reaches the air-permeable filter through the air inlet and the air flow path, so that the air-permeable filter is not exposed directly outside the gas sensor, thus minimizing the adhesion of pollution objects to the air-permeable filter and clogging thereof

The vertical hole extends vertically of the gas sensor within the elastic member and has the open end oriented inside the air cover and the closed end oriented to the base end of the elastic member, thus avoiding the intrusion of water into the vertical hole from the base end of the elastic member and into the end of the support.

The air-permeable filter is nipped elastically between the elastic member and the support, thereby ensuring the adhesion between the elastic member and the air-permeable filter even if the air-permeable filter is subjected to the heat during use of the gas sensor so that it shrinks or expands thermally.

Specifically, even if the air-permeable filter is thermally deteriorated, the elastic pressure, as produced by crimping the air cover to press the elastic member radially, servers to keep the adhesion between surfaces of contact of the air-permeable filter and the elastic member, thus compensating for a decrease in waterproofing ability of the air-permeable filter,

The air-permeable filter is retained within the vertical hole of the elastic member. In other words, the air-permeable filter is disposed inside the elastic member which is lower in thermal conductivity, thus decreasing the transfer of heat from outside the gas sensor to the air-permeable filter through the air cover to minimize the thermal deterioration of the air-permeable filter

The air cover has the crimped recesses separated vertically and the ar inlet located between the crimped recesses thereby minimizing the intrusion of water into the air cover from a clearance between the air cover and the air-permeable filter without sacrificing the entrance of air into the air-permeable filter.

In the preferred mode of the invention, the support is made of a collection of core wires.

The support is made of the collection of the core wires twisted. The support is circular in transverse section thereof.

The air-permeable filter may be made of a coat on the support.

The elastic member may be made up of a plurality of blocks placed on each other in alignment. The air flow path is defined between the blocks. At least one of the blocks may have a plurality of protrusions placed in contacting abutment with another of the blocks.

The elastic member has an outer air-inlet groove formed in the whole of an outer circumference thereof. The air flow path has an outer opening formed in the outer air-inlet groove. This facilitates the ease of flow of the air which has entered at the air inlet to the outer opening of the air flow path.

The elastic member also has an inner air-inlet groove formed in the whole of an inner circumference thereof. The air flow path has an inner opening formed in the inner air-inlet groove. This facilitates the ease of flow of the air which has entered the air flow path to the air-permeable filter.

The air inlet and the air flow path may be oriented out of alignment with each other, thereby preventing pollution objects from reaching the air-permeable filter directly to avoid clogging of the air-permeable filter.

The air-permeable filter may be made of a porous PTFE which is high in waterproofing, heat resistance, and chemical resistance properties.

The gas sensor may further comprises air inlet holes formed in the portion of the wall of the air cover between the crimped recesses. The air inlets may be located away from each other in the lengthwise direction of the gas sensor, which ensures the draining of water from the air inlets which has intruded into the air flow path from the air inlets even if the elastic member is misaligned vertically. This avoids staying of water in the air flow path to keep the air-permeable filter dry. This structure also ensures the admission of the air into the air flow path through the air inlets even if the elastic member is misaligned vertically.

The air inlet may alternatively be formed by a hole elongated in the lengthwise direction of the gas sensor. This offers the same advantages as when the air inlets are, as described above, located away from each other in the lengthwise direction of the gas sensor and also serves to avoid the intrusion of large-sized objects into the air cover.

The air cover may be made of metal such as stainless steel which is high in heat resistance, durability, and mechanical strength in environments of use of the gas sensor. The use of the metal enhances the resistance to reactive pressure from the elastic member at the crimped recesses.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a longitudinal sectional view which shows a gas sensor according to the first embodiment of the invention;

FIG. 2 is a partially enlarged sectional view which shows the structure of an elastic member fit in an open end of an air cover of the gas sensor of FIG. 1;

FIG. 3 is a partially enlarged sectional view of the elastic member, as viewed from a direction perpendicular to that in FIG. 2;

FIG. 4 is a transverse sectional view, as taken along the line A-A in FIG. 2;

FIG. 5 is a transverse sectional view, as taken along the line B-B in FIG. 2;

5 FIG. 6 is an exploded view which shows an elastic member and an assembly of an air-permeable filer and a support installed in the gas sensor of FIG. 1;

FIG. 7 is a longitudinal sectional view which shows an elastic member in which an assembly of an air-permeable filer and a support is installed in the gas sensor of FIG. 1;

FIG. 8 is a transverse sectional view which shows the assembly of the air-permeable filer and the support in FIG. 7;

FIG. 9 is a side view which shows an elastic member installed in the gas sensor of FIG. 1,

FIG. 10 is a longitudinal sectional view which shows a gas sensor according to the second embodiment of the invention;

FIG. 11 is a side view which shows an elastic member according to the third embodiment of the invention in which an assembly of an air-permeable filter and a support is fit;

FIG. 12 is an exploded view which shows the elastic member of FIG. 11;

FIG. 13 is a partially enlarged sectional view which shows the structure of the elastic member, as illustrated in FIG. 11, fit in an open end of an air cover of a gas sensor;

FIG. 14 is a transverse sectional view, as taken along the line C-C in FIG. 13;

FIG. 15 is a partially longitudinal sectional view which shows an air cover in which an elastic member is installed in a gas sensor according to the fourth embodiment of the invention;

FIG. 16 is a partially longitudinal sectional view which shows an air cover in which an elastic member is installed in a gas sensor according to the fifth embodiment of the invention; and

FIG. 17 is a longitudinal sectional view which shows an example of a conventional gas sensor.

### DESCRIPTION OF THE PREFERRED EMBODIMENTS

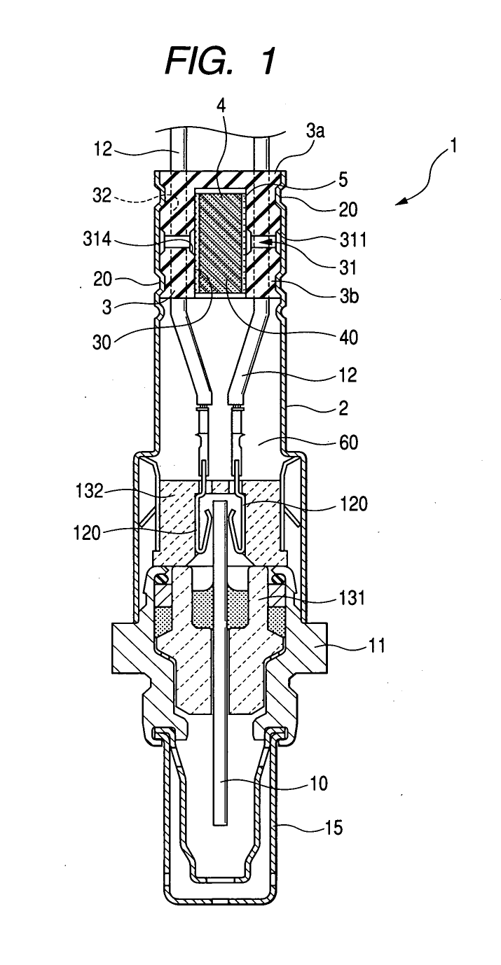

Referring to the drawings, wherein like reference numbers refer to like parts in several views, particularly to FIG. 1, there is shown a gas sensor 1 according to the first embodiment of the invention which may be employed as an oxygen sensor, a NOx sensor, or an air-fuel ratio sensor installed in an exhaust pipe of automotive internal combustion engines.

The gas sensor 1 has a length with a top end (i.e., a lower end, as viewed in FIG. 1) and a base end (i.e., an upper end, as viewed in FIG. 1) and includes a sensing device 10, a hollow cylindrical housing 11, an air cover 2, leads 12, and an elastic bush 3. The sensing device 10 is sensitive to the concentration of gas and outputs a signal indicative thereof. The housing 11 retains the sensing device 10 therein. The air cover 2 is joined or welded at a top end thereof (i.e., a lower end, as viewed in FIG. 1) to a base end (i.e., an upper end, as viewed in FIG. 1) of the housing 10. The leads 12 extend within the air cover 12 and connect with an end of the sensing device 10 The elastic bush 3 is fit hermetically in an opening of the base end of the air cover 2 to retain the leads 12 therein

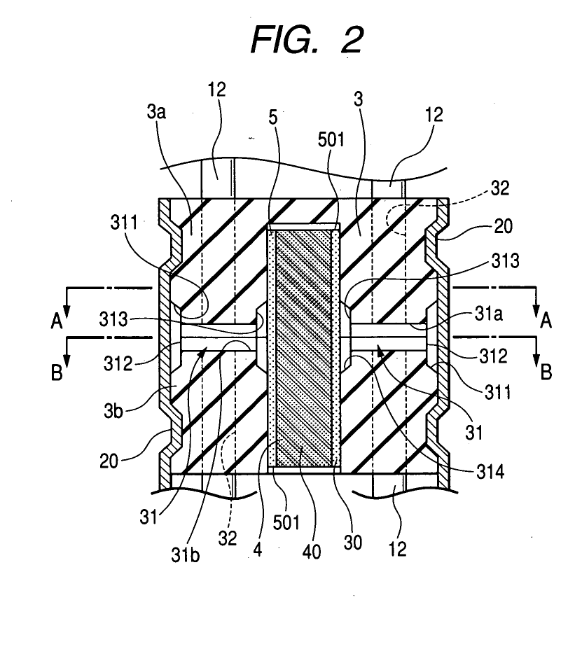

The elastic bush 3 is, as clearly illustrated in FIGS. 2 to 5, shaped to have a vertical center hole 30 which has an inner end opening inside the air cover 2 and an outer end closed and defines a central cylindrical chamber in which a filter assembly, as will be described later in detail, is disposed. The elastic bush 3 also has horizontal holes 31 and four vertical lead-retaining holes 32 formed therein. The horizontal holes 31 extend in alignment with each other in a direction perpendicular to a longitudinal center line of the elastic bush 3 and define air flow paths which establish communications between the center hole 30 and outside the elastic bush 3. The lead-retaining holes 32 retain the leads 12 extending therethrough.

A hollow cylindrical air-permeable filter 5 is fit in the center hole 30. An air-permeable support 4 is disposed in the filter 5, The filter 5 is retained by an elastic nip between the inner wall of the center hole 30 and the outer wall of the support 4. Specifically, the filter 5 is press-fit in the center hole 30 so that it is retained elastically between the support 4 and the elastic bush 3. The filter 5 may alternatively be loose-fit in the center hole 30. In this case, the filter 5 is retained firmly by, as described later, crimping the air cover 2 inwardly to exert elastic pressure on the filter 5 through the elastic bush 3.

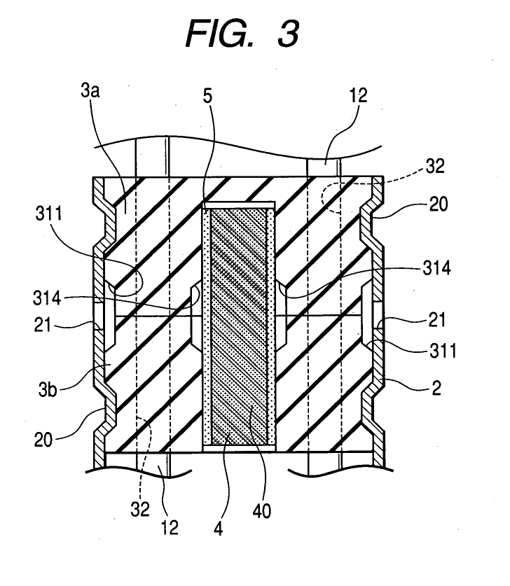

The air cover 20, as illustrated in FIGS. 1 to 3, has two annular grooves 20 formed by crimping a peripheral wall thereof to elastically press the elastic bush 3 in a radius direction thereof to nip the leads 12 firmly. The air cover 20, as can be seen in FIG. 3, also has two air inlets 21 formed between the annular grooves 20. The horizontal holes 31 of the elastic bush 3 are also located between the annular grooves 20 and communicate with the air inlets 21.

The sensing device 10 is, as illustrated in FIG. 1, retained by a cylindrical gas-exposed insulator 131 fitted in the housing 11. A cylindrical air-exposed insulator 132 is placed on the base end of the housing 11 in alignment with the gas-exposed insulator 131 to cover the base end of the sensing device 10. A protective cover assembly 15 is joined to the top end (i.e., the lower end, as viewed in FIG. 1) of the housing 11 to cover a top end (i.e., a gas-exposed sensing portion) of the sensing device 10.

The sensing device 10 has a typical structure used in gas sensors installed in an exhaust pipe of automotive internal combustion engines, and is equipped with the sensing portion sensitive to the concentration of gas, a heater (not shown) for heating the sensing portion, and terminals (not shown) connecting electrically with the sensing portion and the heater. The terminals are joined to the four leads 12 through connector terminals 120 disposed inside the air-exposed insulator 132.

The leads 12 extend within the air cover 2 and pass through the lead-retaining holes 32 of the elastic bush 3 for electrical connection with an external device or sensor controller.

The air cover 2 is made of stainless steel and, as described above, has the crimped annular grooves 20 located at a given interval away from each other in the longitudinal direction thereof. The elastic rush 3 is pressed inwardly by the annular grooves 20 of the air cover 2 to establish firm adhesion between the leads 12 and the lead-retaining holes 32 of the elastic bush 3.

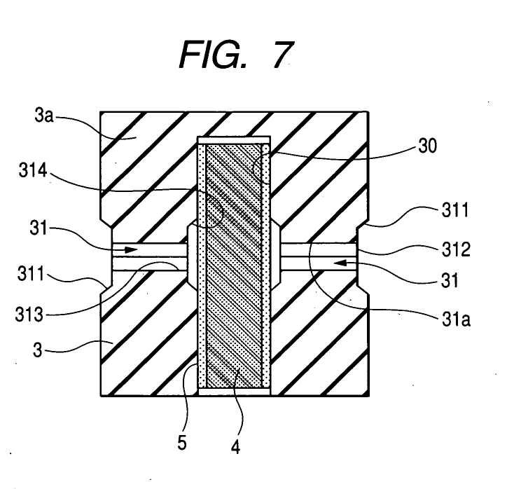

The elastic bush 3 is, as illustrated in FIGS. 1 to 3, 6, and 7, made of two separate cylindrical blocks 3a and 3b which are aligned in the longitudinal direction of the air cover 2 to define the two horizontal holes 31 (i.e., the air flow paths). Specifically, each of the cylindrical blocks 3a and 3b, as can be seen in FIG. 6, has two semi-circular grooves 31a or 31b extending in alignment with each other in the radius direction thereof The cylindrical blocks 3a and 3b are, as illustrated in FIG. 7, placed on each other to have the grooves 31a and 31b face each other to define the horizontal holes 31.

The elastic bush 3, as illustrated in FIGS. 1 to 7, and 9, has formed in a peripheral side wall thereof an annular outer air-inlet groove 311 extending around the whole of the outer circumference thereof. The horizontal holes 31 have outer openings 312 formed in the bottom of the outer air-inlet groove 311. The elastic bush 3 also has an annular inner air-inlet groove 314 formed in an inner peripheral side wall defining the vertical hole 30. The inner air-inlet groove 314 extends around the whole of the inner circumference of the elastic bush 3. The horizontal holes 31 have inner openings 313 formed in the bottom of the inner air-inlet groove 314.

The elastic bush 3, as described above, has the vertical hole 30 opening at the top end thereof The air-permeable filter 5 and the breathable support 4 are disposed firmly inside the vertical hole 30.

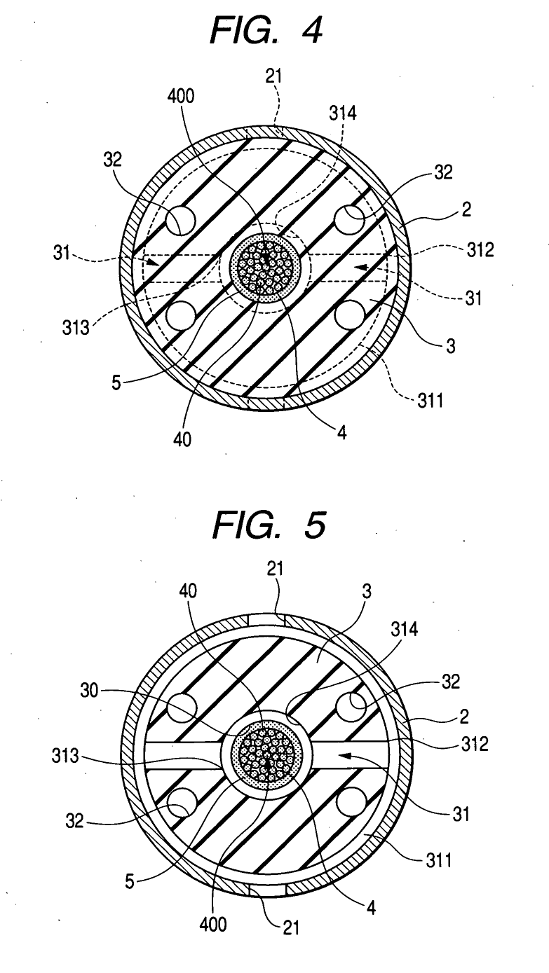

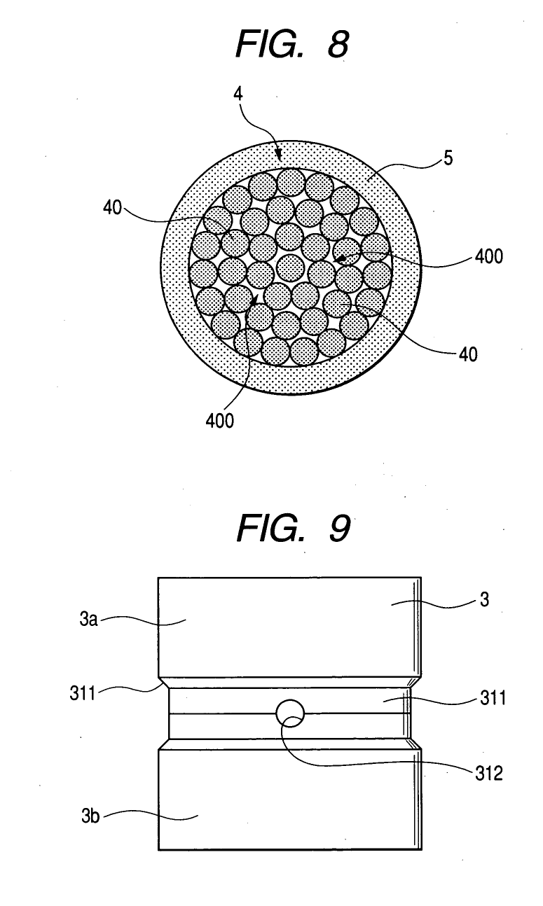

The support 4 is, as illustrated in FIGS. 1 to 8, made of a plurality of core wires 40 twisted together. Specifically, the core wires 40 are, as can be seen from FIGS. 4, 5, and 8, twisted into a cylindrical bar which is substantially of a circular shape in transverse cross section. Each of the core wires 40 may be made of copper, stainless steel, or nickel The support 4 may be made of a sintered porous metallic material.

The air-permeable filter 5 is made of a porous PTFE (polytetrafluoroethylene) and coats or covers the periphery of the support 4.

The support 4 and the air-permeable filter 5 constitute a filter assembly which may be fabricated by twisting the core wires 40 together to form a bundle of the core wires 40, coating the outer periphery of the bundle with PTFE, and cutting it to a required length.

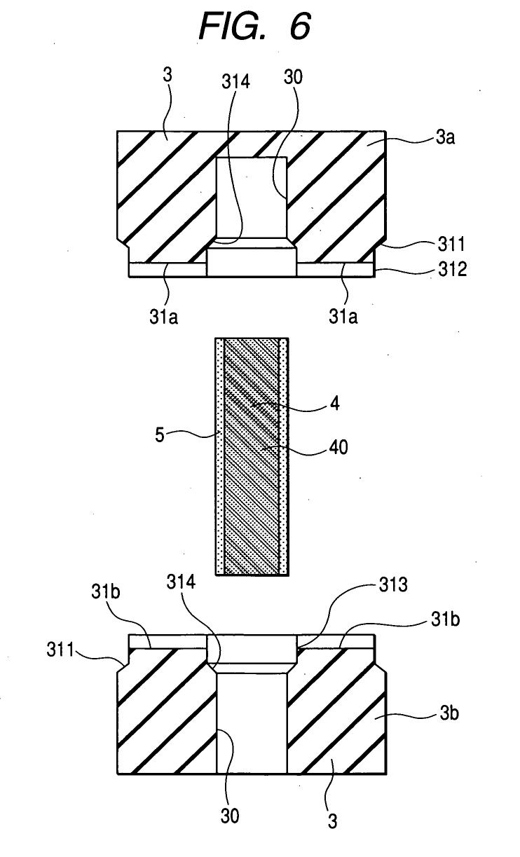

The air inlets 21 of the air cover 2 are, as can be seen from FIGS. 4 and 5, located out of coincidence with the horizontal holes 31 Specifically, the air inlets 21 are 90° apart from the horizontal holes 31 in a circumferential direction of the air cover 2.

A flow of air introduced into the gas sensor 1 will be described below in detail.

After entering the air inlets 21 of the air cover 2, the air goes within the outer air-inlet groove 311 formed around the outer periphery of the elastic bush 3 into the horizontal holes 31 at the outer openings 312. Subsequently, the air emerges from the horizontal holes 31, flows through the inner air-inlet groove 314, and then enters the support 4 through the air-permeable filter 5. Finally, the air goes out of the support 4 into an air chamber 60 defined between the elastic bush 3 and the air-exposed insulator 132 within the air cover 2 and enters a reference gas chamber formed in the sensing device 10,

The elastic bush 3, as described above, has the assembly of the support 4 and the air-permeable filter 5 fit in the vertical hole 30. After entering the horizontal holes 31 the air passes through the air-permeable filter 5 and then flows into spaces or gaps 400 between the core wires 40 of the support 4, Subsequently, the air goes out of the gaps 400 and advances in the air chamber 60 within the air cover 2.

The installation of the air-permeable filter S in the elastic bush 3 may be achieved by combining the air-permeable filter 5 and the support 4 together to form an assembly and fitting the assembly in the vertical hole 30. The assembly of the air-permeable filter 5 and the support 4 may be made by combining a collection of the twisted core wires 40 and a hollow cylindrical porous material for the support 4 together and cutting such a combination to a required length. This facilitates ease of installing the air-permeable filter 5 and the support 4 in the elastic bush 3 and results in improved productivity of the gas sensor 1

The air reaches the air-permeable filter 5 through the air-inlets 21 of the air cover 2 and the horizontal holes 31 of the elastic bush 3. In other words, the air-permeable filter 5 is disposed inside the air cover 2 without being exposed directly outside the air cover 2, thereby avoiding the adhesion of pollution objects to the air-permeable filter 5 and clogging thereof.

The vertical hole 30 of the elastic bush 3 is formed to have the open inner end and the closed outer end, thus avoiding the intrusion of water from the base end (i.e. the upper end, as viewed in FIG. 2) of the elastic bush 3 into the base end of the support 4.

The air-permeable filter 5 is retained elastically between the elastic bush 3 and the support 4, thereby ensuring the adhesion between the elastic bush 3 and the air-permeable filter 5 even if the air-permeable filter 5 is subjected to the heat during use of the gas sensor 1 so that it shrinks or expands thermally. Specifically, even if the air-permeable filter 5 is thermally deteriorated) the elastic pressure, as produced by crimping the air cover 2 to press the elastic bush 3 radially, servers to keep the adhesion between surfaces of contact of the air-permeable filter 5 and the elastic bush 3, thus compensating for a decrease in waterproofing ability of the air-permeable filter 5.

The air-permeable filter 5 is, as illustrated in FIGS. 1 to 7, retained within the vertical hole 30 of the elastic bush 3. In other words, the air-permeable filter 5 is disposed inside the elastic bush 3 which is lower in thermal conductivity, thus decreasing the transfer of heat from outside the gas sensor 1 to the air-permeable filter 5 through the air cover 2 to minimize the thermal deterioration of the air-permeable filter 5.

The air cover 2 has, as illustrated in FIGS. 1 to 3, the crimped annular grooves 20 separated vertically and the air inlets 21 located between the annular grooves 20, thereby minimizing the intrusion of water into the air chamber 60 from a clearance between the air cover 2 and the air-permeable filter 5 without sacrificing the entrance of air into the air-permeable filter 5.

Each of the leads 12 is retained firmly at two locations spaced vertically, that is, nipped or grasped by two elastic pressures, as produced by compressing the elastic bush 3 inwardly through the crimped annular grooves 20, thereby minimizing the transmission of physical vibrations of a portion of the lead 12 located outside the gas sensor 1 to inside the gas sensor 1. In other words, the vertically separate elastic nips of each of the leads 12 in the elastic bush 3 work to dampen the vibrations transmitted from outside the gas sensor 1 to the lead 12, thereby decreasing the possibility of disconnection of the lead 12 from the sensing device 10 within the air cover 2.

The support 4 is, as described above in FIGS. 4, 5, and 8, made of the core wires 40 which are twisted together to form the lots of the gaps 400, thus ensuring a desired degree of air permeability of the assembly of the air-permeable filter 5 and the support 4. The twisting of the core wires 40 of the support 4 serves to enhance the adhesion of each of the core wires 40 to the support 4, thus decreasing the possibility of removal of the core wires 40 and the support 4 itself from the air-permeable filter 5.

The air-permeable filter 5 is made of a coat on the support 4. In other words, the assembly of the air-permeable filter 5 and the support 4 is made, as described above, by cutting a bundle of the twisted core wires 40 coated with PTFE to a required length, thus facilitating the ease of installation of the support 4 and the air-permeable filter 5 in the elastic bush 3, which enhances the productivity of the gas sensor 1.

The elastic bush 3 is, as illustrated in FIGS. 1 to 3 and 6 to 9, made of the two discrete cylindrical blocks 3a and 3b placed on each other vertically, thus facilitating the ease of machining the elastic bush 3, e.g., the horizontal holes 31.

The horizontal holes 31, i.e., horizontal air flow paths are formed by coupling the semi-circular grooves 31a and 31b of the cylindrical blocks 3a and 3b together, thus facilitating the ease of formation of the air flow paths extending from the inner air-inlet groove 314 to the outer air-inlet groove 311.

The air-permeable filter 5 has, as illustrated in FIG. 2, the ends 501 not exposed directly to the atmospheric air, thus minimizing the entrance of water into the gas sensor 1 through the air-permeable filter 5.

The elastic bush 3 has, as illustrated in FIGS. 2 to 9, the outer air-inlet groove 311 which extends around the whole of the outer circumference thereof and communicates with the outer openings 312 of the horizontal holes 31, thereby ensuring the flow of the air into the outer openings 312 of the horizontal holes 31 through the outer air-inlet groove 311 from the air inlets 21 of the air cover 2 which are located out of alignment with the outer openings 312.

The air-permeable filter 5 is made of PTFE and, thus, is high in waterproofing, heat resistance, and chemical resistance properties.

The air cover 2 is made of stainless steel and, thus, is high in heat resistance, durability, and mechanical strength in environments of use of the gas sensor 1.

The elastic bush 3 may alternatively be made of a one-piece block to decrease in fabrication process of the gas sensor 1. Instead of the horizontal holes 31, an air flow path extending between the vertical hole 30 and the air inlets 21 may be made by retaining the blocks 3a and 3b at a given interval away from each other in the vertical direction of the elastic bush 3 to form an air gap therebetween,

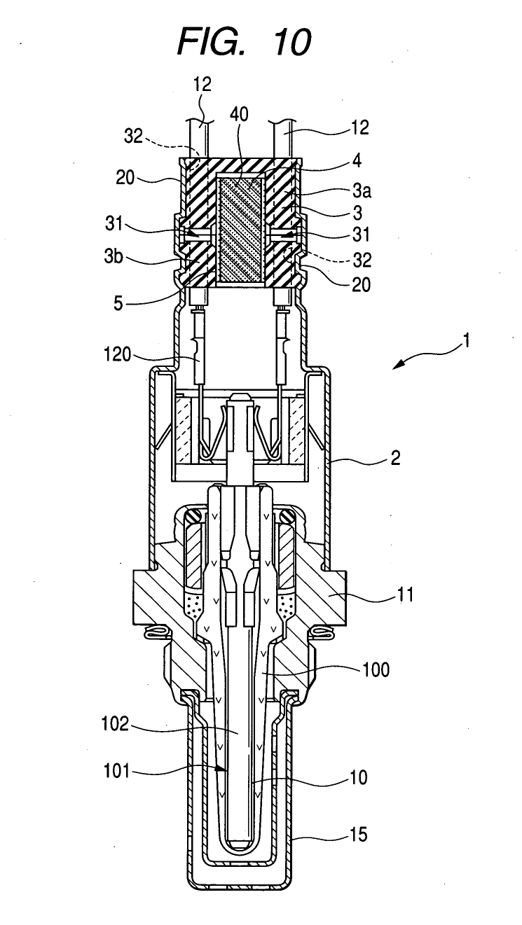

FIG. 10 shows the gas sensor 1 according to the second embodiment of the invention which is equipped with the cup-shaped sensing device 10.

The sensing device 10 is made up of a bottomed hollow cylindrical solid electrolyte body 100 and a pair of electrodes (not shown) affixed to an outer and an inner surface, respectively. The solid electrolyte body 100 has formed therein a reference gas chamber 101 into which the air is admitted as a reference gas and within which a heater 102 is disposed.

The sensing device 10 and the heater 102 have terminals which establish electric connections with the leads 12 through the connector terminals 120. Other arrangements are identical with those in the first embodiment, and explanation thereof in detail will be omitted here.

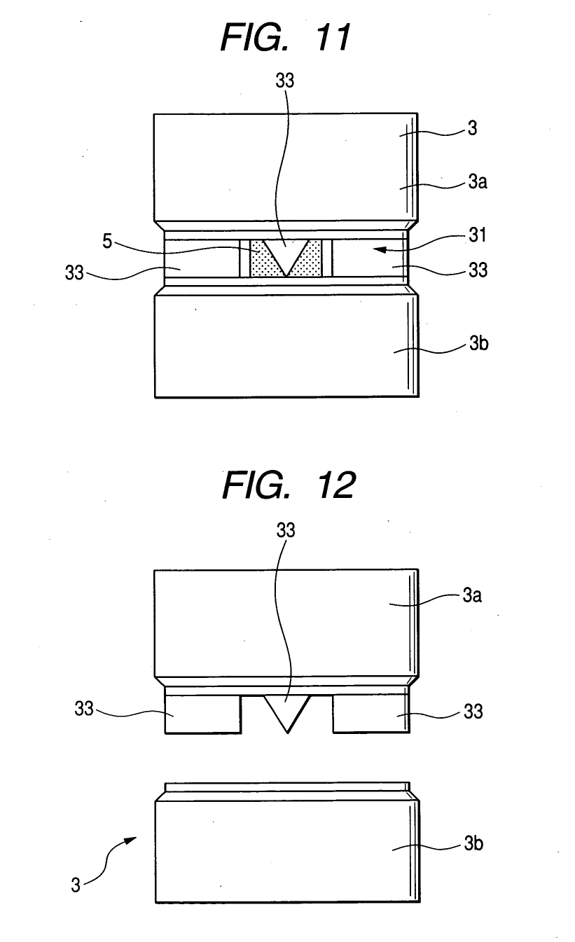

FIGS. 11 to 14 illustrate an elastic bush 3 installed in the gas senor 1 according to the third embodiment of the invention, 5 The elastic bush 3 is made up of the cylindrical blocks 3a and Sb. The block 3a has four protrusions or ridges 33 formed on the top end thereof which faces the top end of the gas sensor 1. The ridges 33 are, as illustrated in FIG. 14, located at a regular interval and taper toward the block 3b. In other words, each of the ridges 33 has a triangular sectional area which traverses the axis of the elastic rubber 3 and decreases toward the top thereof.

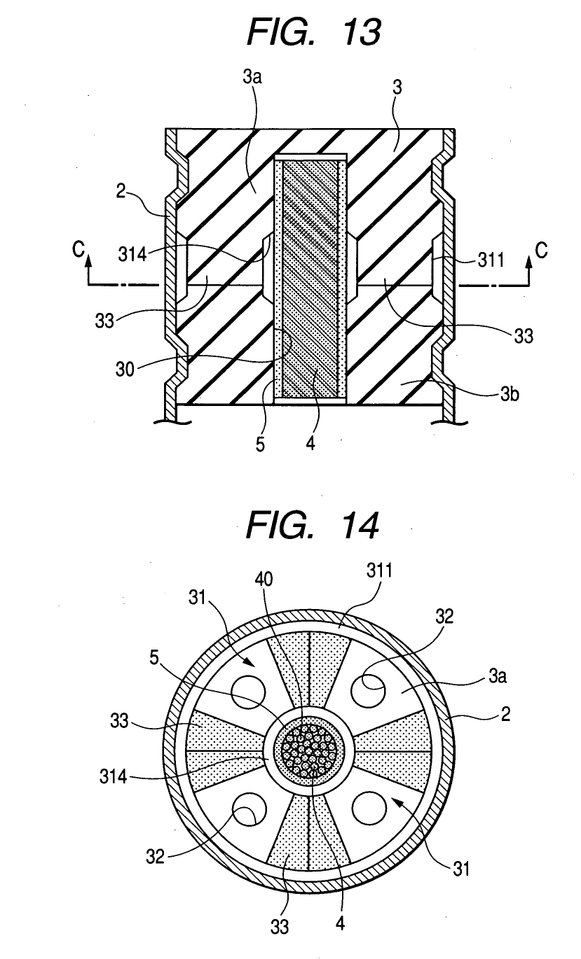

The blocks 3a and 3b are, as illustrated in FIGS. 11 and 13, coupled with each other in contacting abutment of the ridges 3 with the upper end of the block 3b. The assembly of the blocks 3a and 3b defines the vertical hole 30 in which the assembly of the air-permeable filter 5 and the support 4 is installed. The assembly of the blocks 3a and 3b also defines each of the horizontal holes 31 between adjacent two of the ridges 33. The horizontal holes 31 serve as air flow paths each of which establishes communication between the outer air-inlet groove 311 and the inner air-inlet groove 314. Other arrangements are identical with those in the first embodiment, and explanation thereof in detail will be omitted here.

The blocks 3a and 3b are, as apparent from the above discussion joined together at lines of contact therebetween, thereby resulting in a decrease in pressure acting on each other when the blocks 3a and 3b thermally expand, which minimizes the misalignment of the blocks 3a and 3b with the air-permeable filter 5 and the air cover 2 to ensure the waterproofing property of the gas sensor 1,

The block 3a may alternatively be designed to have three or less or five or more ridges 33. The block 3b may also be shaped to have similar ridges. The ridges 33 may alternatively be formed to have another shape different from the one as illustrated in FIGS. 11 and 12.

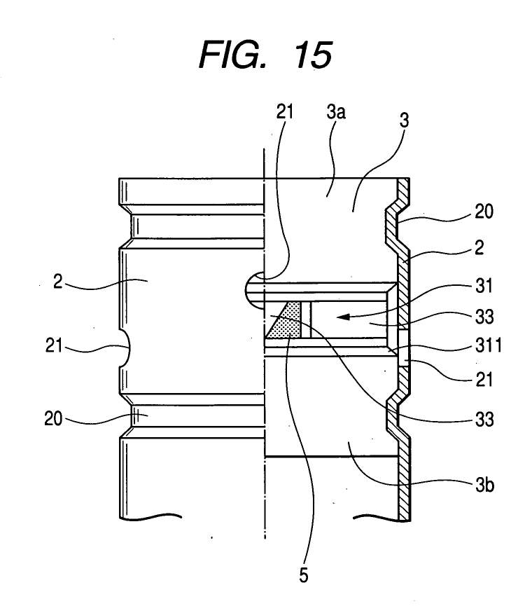

FIG. 15 illustrates the air cover 2 of the gas sensor 1 according to the fourth embodiment of the invention. The elastic bush 3 is identical in structure with the one in the third embodiment.

The air cover 2 has the air inlets 21 shifted vertically, unlike the ones in the first embodiment. Specifically, the four air inlets 21 are disposed at an equi-interval away from each other between the crimped annular grooves 20. Two of the air inlets 21 which are diametrically opposed to each other are located downward, as viewed in FIG. 15, out of alignment of the centers thereof with those of the horizontal holes 31, while the other two air inlets 21 are located upward out of alignment of the centers thereof with those of the horizontal holes 31. In other words, adjacent two of the air inlets 21 are, as can be seen from FIG. 15, shifted vertically with respect to the outer air-inlet groove 311. Each of the air inlets 21 is, as can be seen from the drawing, faces either of sides of the outer air-inlet groove 311. Other arrangements are identical with those in the third embodiment, and explanation thereof in detail will be omitted here.

The above structure of the air cover 2 establishes at least communication of diametrically opposed two of the air inlets 21 with the outer air-inlet groove 311 even if the elastic bush 3 is misaligned vertically, thereby ensuring the draining of water from the air inlets 21 which has intruded into the horizontal holes 31 from the air inlets 21. This avoids staying of water in the horizontal holes 31 to keep the air-permeable filter 5 dry.

The structure of the air cover 2 also ensures the admission of air into the horizontal holes 31 through the air inlets 21 even if the elastic bush 3 is misaligned vertically.

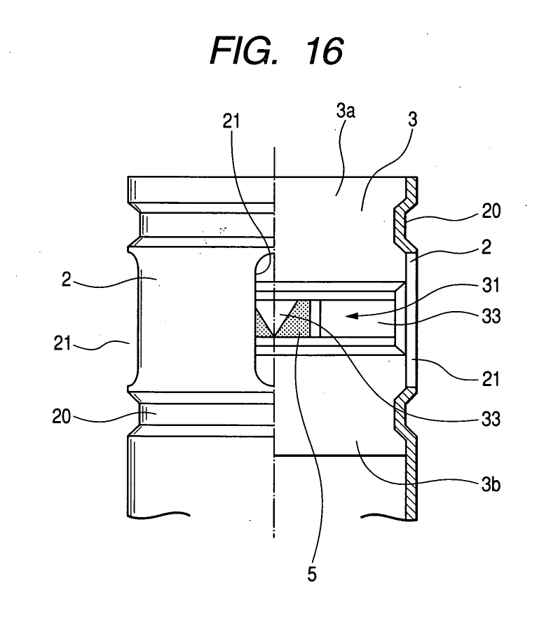

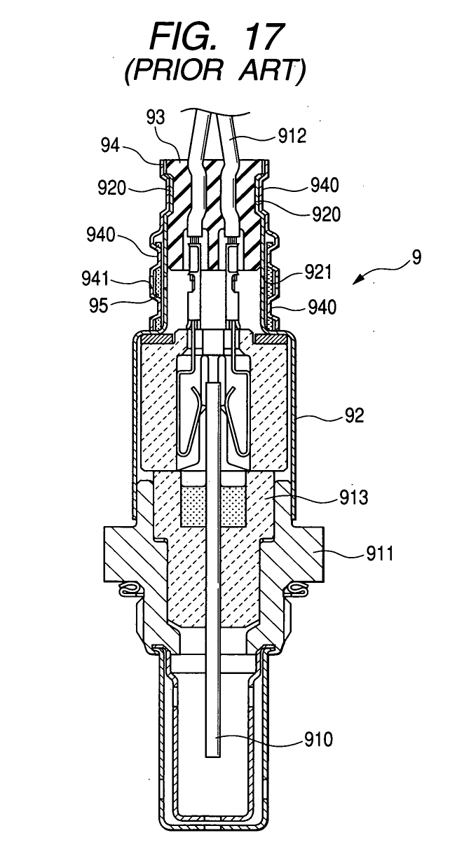

FIG. 16 illustrates the air cover 2 of the gas sensor 1 according to the fifth embodiment of the invention. The elastic bush 3 is identical in structure with the one in the third embodiment.

The air cover 2 has the air inlets 21 which are elongated vertically of the gas sensor 1 to have a length at least greater than the width of the outer air-inlet groove 311. Specifically, each of the air inlets 21 has a base end (i.e., an upper end, as viewed in FIG. 16) closer to the base end of the gas sensor 1 than the outer air-inlet groove 311 and a top end (i.e., a lower end, as viewed in FIG. 16) closer to the top end of the gas sensor 1 than the outer air-inlet grove 311. Other arrangements are identical with those in the third embodiment, and explanation thereof in detail will be omitted here.

The above structure of the air cover 2 establishes the communication of the air inlets 21 with the outer air-inlet groove 311 even if the elastic bush 3 is misaligned vertically, thereby ensuring the draining of water from the air inlets 21 which has intruded into the horizontal holes 31 from tie air inlets 21. This avoids staying of water in the horizontal holes 31 to keep the air-permeable filter 5 dry.

The structure of the air cover 2 also ensures the admission of air into the horizontal holes 31 through the air inlets 21 even if the elastic bush 3 is misaligned vertically.

The elongated air inlets 21 are also effective for avoiding the entrance of large-sized foreign objects into the air cover 2.

While the present invention has been disclosed in terms of the preferred embodiments in order to facilitate better understanding thereof it should be appreciated that the invention can be embodied in various ways without departing from the principle of the invention. Therefore, the invention should be understood to include all possible embodiments and modifications to the shown embodiments witch can be embodied without departing from the principle of the invention as set forth in the appended claims.

What is claimed is:

1. A gas sensor having a length with a base end and a top end opposed to the base end, comprising:
a housing having a base end facing the base end of the gas sensor and a top end facing the top end of the gas sensor;
a sensing device that measures a concentration of gas and provides a signal indicative thereof, said sensing device being retained inside said housing;
an air cover having a length with a base end and a top end opposed to the base end, said air cover being joined at the top end thereof to the base end of said housing to extend along the length of the gas sensor toward the base end of the gas sensor, the base end of said air cover having an opening;
leads coupled electrically with said sensing device, said leads extending outside said air cover through the opening of the base end of said air cover;
an elastic member having a top end and a base end opposed to the top end, said elastic member being disposed hermetically in the opening of the base end of said air cover, said elastic member having a vertical hole, an air flow path, and lead-retaining holes through which said leads pass, the vertical hole extending vertically of the gas sensor within the elastic member to have an open end oriented inside said air cover and a closed end opposed to the open end, the air flow path extending from the vertical hole to an outer peripheral surface of said elastic member;
a hollow cylindrical air-permeable filter disposed in the vertical hole of said elastic member;
an air-permeable support fit in the air-permeable filter to form an elastic nip along with said elastic member in which said air-permeable filter is heid;
a plurality of crimped recesses in an wall of said air cover which exert mechanical pressure on said elastic member inwardly in a radius direction of said elastic member, said crimped recesses being located away from each other in a lengthwise direction of said air cover; and
an air inlet formed in a portion of the wall of said air cover between said crimped recesses, said air inlet communicating with the air flow path to admit air into said air-permeable filter.

2. A gas sensor as set fort in claim 1, wherein said support is made of a collection of core wires.

3. A gas sensor as set forth in claim 2, wherein said support is made of the collection of the core wires twisted.

4. A gas sensor as set forth in claim 2, wherein said support is circular in transverse section thereof.

5. A gas sensor as set forth in claim 1, wherein said air-permeable filter is made of a coat on said support.

6. A gas sensor as set forth in claim 1, wherein said elastic member is made up of a plurality of blocks placed on each other in alignment.

7. A gas sensor as set forth in claim 6, wherein the air flow path is defined between the blocks.

8. A gas sensor as set forth in claim 6, wherein at least one of the blocks has a plurality of protrusions placed in contacting abutment with another of the blocks.

9 A gas sensor as set forth in claim 1, wherein said elastic member has an outer air-inlet groove formed in a whole of an outer circumference thereof, and wherein the air flow path has an outer opening formed in the outer air-inlet groove.

10. A gas sensor as set forth in claim 1, wherein said elastic member has an inner air-inlet groove formed in a whole of an inner circumference thereof, and wherein the air flow path has an inner opening formed in the inner air-inlet groove.

11. A gas sensor as set forth in claim 1, wherein the air inlet and the air flow path are oriented out of alignment with each other,

12. A gas sensor as set forth in claim 1, wherein said air-permeable filter is made of a porous PTFE.

13. A gas sensor as set forth in claim 1, further comprising air inlet holes formed in the portion of the wall of said air cover between said crimped recesses, and wherein said air inlets are located away from each other in a lengthwise direction of the gas sensor.

14. A gas sensor as set forth in claim 1, wherein said air inlet is formed by a hole elongated in a lengthwise direction of the gas sensor

15. A gas sensor as set forth in claim 1, wherein said air cover is made of metal.
